(19) United States
(12) Patent Application Publication
(10) Pub. No.: US 2024/0176096 A1
(43) Pub. Date: May 30, 2024

(54) OPTICAL ELEMENT DRIVING APPARATUS, CAMERA MODULE AND CAMERA-EQUIPPED APPARATUS

(71) Applicants: Yukihiro TAKIMOTO, Tokyo (JP); Masahiko ARANAI, Tokyo (JP)

(72) Inventors: Yukihiro TAKIMOTO, Tokyo (JP); Masahiko ARANAI, Tokyo (JP)

(73) Assignee: MITSUMI ELECTRIC CO., LTD., Tokyo (JP)

(21) Appl. No.: 18/520,627

(22) Filed: Nov. 28, 2023

(30) Foreign Application Priority Data
Nov. 30, 2022 (JP) 2022-191182

(51) Int. Cl. G02B 7/04; H04N 23/54; H04N 23/55

(52) U.S. Cl. CPC G02B 7/04; H04N 23/54; H04N 23/55

(57) ABSTRACT

An optical element driving apparatus includes: a movable part; a housing part configured to surround an outer periphery of the movable part and house the movable part, the housing part having a rectangular shape in plan view; a fixing part disposed on one side in an optical axis direction with respect to the movable part and the housing part; a leaf spring member configured to support the movable part such that the movable part is movable in the optical axis direction; and a wire member configured to support the housing part such that the housing part is movable in an optical axis orthogonal direction with respect to the fixing part. The wire member is configured such that a wire group including two or more wire members is disposed at each of four corners of the housing part and connected to a common leaf spring member.

### CROSS REFERENCE TO RELATED APPLICATIONS

This application is entitled to or claims the benefit of Japanese Patent Application Nos. 2022-191182, filed on Nov. 30, 2022, the disclosure of which including the specification, drawings and abstract is incorporated herein by reference in its entirety.

### TECHNICAL FIELD

The present invention relates to an optical element driving apparatus, a camera module and a camera-equipped apparatus.

### BACKGROUND ART

In general, a small-sized camera module is mounted in mobile terminals such as smartphones. For such a camera module, an optical element driving apparatus for driving optical elements is used.

The optical element driving apparatus has an auto focus function (hereinafter referred to as “AF function”; AF: Auto Focus) and a shake correction function (hereinafter referred to as “OIS function”; OIS: Optical Image Stabilization). The optical element driving apparatus automatically performs the focusing when capturing a subject by using the AF function, and optically corrects the runout (vibration) caused in capturing an image by using the OIS function to reduce image distortion.

For example, PTL 1 discloses an optical element driving apparatus with an AF function and an OIS function. The optical element driving apparatus disclosed in PTL 1 includes a movable part that can hold an optical element and includes a coil, a housing part with a quadrangular cylindrical shape that includes a magnet and houses the movable part in a movable manner in the optical axis direction (optical axis direction), and a fixing part that supports the movable part and the housing part in a movable manner in the direction intersecting the optical axis (optical axis orthogonal direction).

In addition, for example, the optical element driving apparatus disclosed in PTL 1 includes a leaf spring member mounted to the housing part to support the movable part from the upper opening side of the movable part, and two wire members extended between the fixing part and the leaf spring member in a manner corresponding to each of the four corners of the housing part so as to support the housing part. The two wire members at each of the four corners of the housing part are connected to respective different leaf spring members.

### CITATION LIST

### Patent Literature

PTL 1
Japanese Patent Application Laid-Open No. 2016-180836

### SUMMARY OF INVENTION

### Technical Problem

However, in the optical element driving apparatus disclosed in PTL 1, the two wire members at each of the four corners of the housing part are connected to respective different leaf spring members, and therefore the wire members at the corner are different electrical paths. Since the wire members are displaced at the corner, there is the risk of the contact between the wire members, and in turn the risk of short circuit and the like.

An object of the present invention is to provide an optical element driving apparatus, a camera module and a camera-equipped apparatus that can stabilize the electric connection.

### Solution to Problem

An optical element driving apparatus according to an aspect of the present invention includes: a movable part configured to hold an optical element; a housing part with a cylindrical shape configured to surround an outer periphery of the movable part and house the movable part, the housing part having a rectangular shape in plan view; a fixing part disposed on one side in an optical axis direction with respect to the movable part and the housing part; a leaf spring member configured to support the movable part such that the movable part is movable in the optical axis direction with respect to the housing part; and a wire member configured to support the housing part such that the housing part is movable in an optical axis orthogonal direction with respect to the fixing part. The wire member is configured such that a wire group including two or more wire members is disposed at each of four corners of the housing part and connected to a common leaf spring member.

A camera module according to an aspect of the present invention includes: the above-described optical element driving apparatus; the optical element; and an image-capturing part configured to capture a subject image formed by the optical element.

A camera-equipped apparatus according to an aspect of the present invention is an information apparatus or a transport apparatus, the camera-equipped apparatus including: the above-described camera module; and an image processing part configured to process image information obtained by the camera module.

### Advantageous Effects of Invention

According to the present invention, the electric connection can be stabilized.

### BRIEF DESCRIPTION OF DRAWINGS

FIG. 1A is a front view of an example of a camera-equipped apparatus equipped with a camera module according to an embodiment of the present invention, and FIG. 1B is a rear view of an example of the camera-equipped apparatus according to the embodiment of the present invention;

FIG. 2A is a front view of another example of the camera-equipped apparatus equipped with the camera module according to the embodiment of the present invention, and FIG. 2B is a perspective view of another example of the camera-equipped apparatus according to the embodiment of the present invention;

FIG. 3 is a perspective view schematically illustrating a configuration of the camera module according to the embodiment of the present invention;

FIG. 4 is a perspective view illustrating an external appearance of an optical element driving apparatus of the camera module according to the embodiment of the present invention;

FIG. 5 is an exploded perspective view of a state where a cover is detached from the optical element driving apparatus in the camera module according to the embodiment of the present invention, as viewed from above;

FIG. 6 is an exploded perspective view of the state illustrated in FIG. 5 according to the embodiment of the present invention, as viewed from below;

FIG. 7 is an exploded perspective view illustrating an internal configuration in a state where the cover is detached in the optical element driving apparatus illustrated in FIG. 5 according to the embodiment of the present invention;

FIG. 8 is a plan view illustrating a leaf spring member according to the embodiment of the present invention as viewed from above;

FIG. 9 is an enlarged plan view illustrating in an enlarged manner the part A in FIG. 8 of the leaf spring member according to the embodiment of the present invention;

FIG. 10 is an enlarged plan view illustrating in an enlarged manner the part A in FIG. 8 of a leaf spring member according to modification 1 of the present invention; and

FIG. 11 is an enlarged plan view illustrating in an enlarged manner the part A in FIG. 8 of a leaf spring member according to modification 2 of the present invention.

### DESCRIPTION OF EMBODIMENTS

An embodiment of the present invention is elaborated below with reference to the accompanying drawings.

### Configuration of Camera-Equipped Apparatus

First, a camera-equipped apparatus in which the camera module according to the embodiment of the present invention is applied is described.

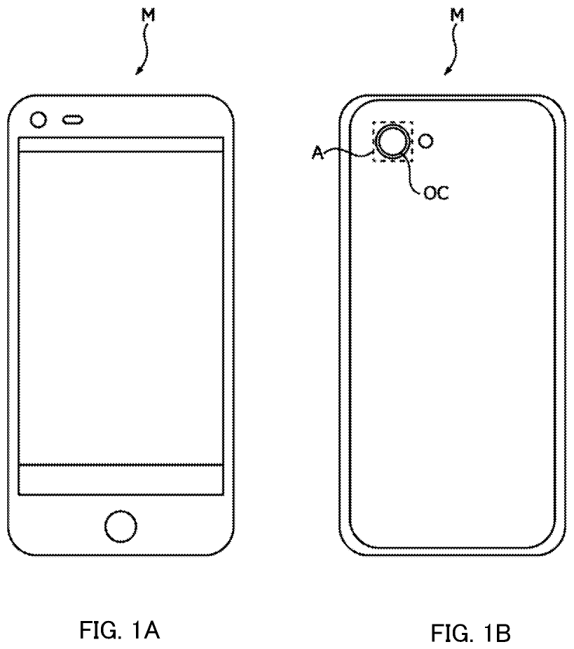

FIGS. 1A and 1B are diagrams illustrating smartphone M (an example of the camera-equipped apparatus) equipped with camera module A. FIG. 1A is a front view of smartphone M, and FIG. 1B is a rear view of smartphone M. Smartphone M includes one or more back surface cameras OC. Camera module A is applied to back surface camera OC.

Smartphone M is a camera-equipped apparatus serving as an information apparatus. Smartphone M includes camera module A, and an image processing part that processes image information obtained by camera module A. Camera module A has an AF function and an OIS function, and can capture blur-free images by automatically performing the focusing for capturing a subject and optically correcting the runout (vibration) caused upon capturing the image.

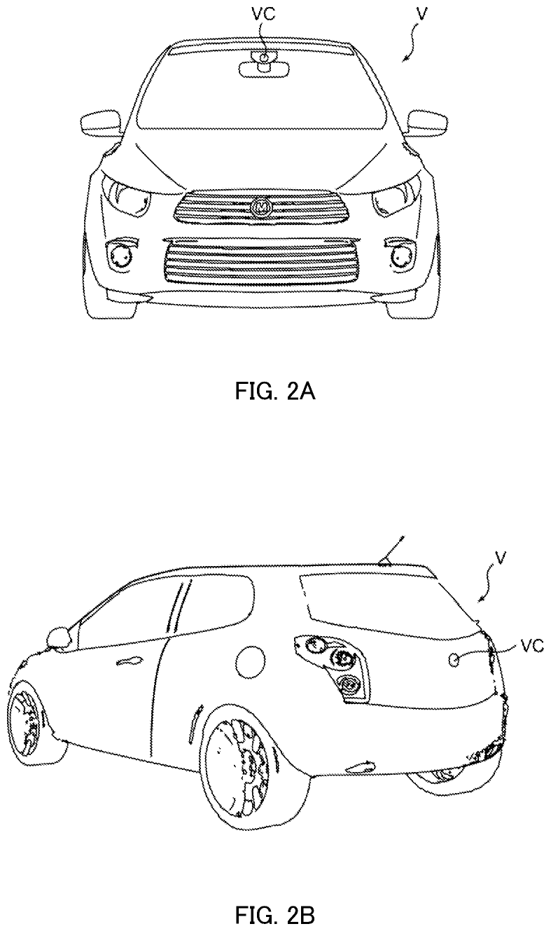

FIGS. 2A and 2B are diagrams illustrating automobile V (another example of the camera-equipped apparatus) equipped with in-vehicle camera module VC (Vehicle Camera). FIG. 2A is a front view of automobile V, and FIG. 2B is a rear perspective view of automobile V. As illustrated in FIGS. 2A and 2B, in-vehicle camera module VC is attached to the windshield to face the front side, and/or attached to the rear gate to face the rear side, for example. In-vehicle camera module VC is used for rear-view monitors, drive recorders, collision-avoidance control, automated driving control and the like. Camera module A is applied in in-vehicle camera module VC of automobile V.

In-vehicle camera module VC is a camera-equipped apparatus serving as a transport apparatus. In-vehicle camera module VC includes camera module A, and an image processing part that processes image information obtained by camera module A. In-vehicle camera module VC has an AF function and an OIS function, and can capture blur-free images by automatically performing the focusing for capturing a subject and optically correcting the runout (vibration) caused upon capturing the image.

Note that the optical element driving apparatus can be applied to various camera-equipped apparatuses. For example, the camera-equipped apparatus includes various information apparatuses transport apparatuses. The information apparatus includes camera-equipped mobile phones, note-type personal computers, tablet terminals, mobile game machines and web-cameras, for example. In addition, the transport apparatus includes camera-equipped in-vehicle apparatuses (e.g., rear-view monitor apparatuses and drive recorder apparatuses), drones and the like, for example.

### Configuration of Camera Module A

Next, a schematic configuration of camera module A is described. Orthogonal coordinate systems (X, Y, Z) are used here. It goes without saying that the expressions regarding shape are expressions of convenience for a simplified outline description, and not necessarily the definition of a geometrically precise figure.

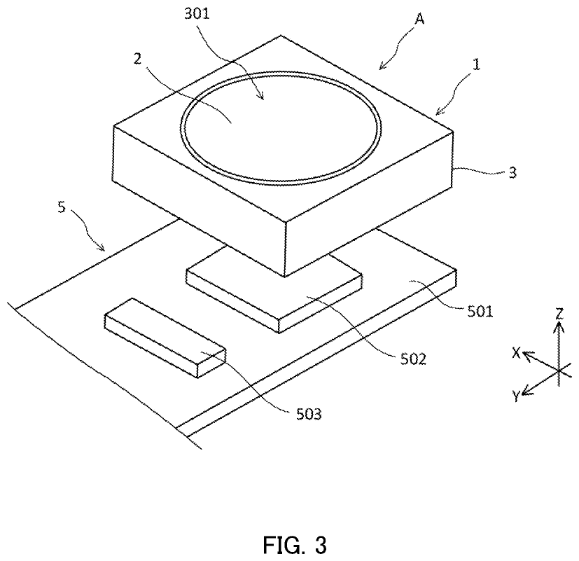

FIG. 3 is a perspective view schematically illustrating a configuration of camera module A. Camera module A is mounted such that the X direction is the up-down direction (or the left-right direction), the Y direction is the left-right direction (or the up-down direction), and the Z direction is the front-rear direction when images are captured with smartphone M, for example. Specifically, the Z direction is the optical path direction, and the upper side (+Z side) and the lower side (−Z side) in FIG. 3 are the light reception side (referred to also as macro position side) and the image-capturing side (referred to also as infinity position side), respectively, in the optical path direction. The direction orthogonal to the Z direction is the optical path orthogonal direction. The X direction and the Y direction are examples of the optical path orthogonal direction.

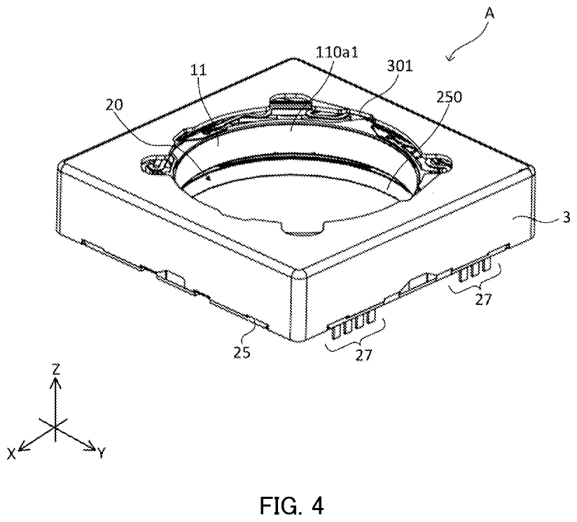

FIG. 4 is a perspective view of an external appearance of optical element driving apparatus 1 of camera module A. As illustrated in FIG. 4, the optical path as the route of light is formed by opening 301 of cover 3, lens housing opening 110a1 for housing lens part 2 in AF focusing part 11, and center opening 250 facing imaging element 502 in OIS foundation part 20. The extending direction of the optical path (the extending direction of each opening) is the optical path direction. The optical path direction may be referred to also as other names such as the optical axis direction and the focusing direction (focus adjusting direction) on the basis of the type of the optical element. In addition, the optical path orthogonal direction may be referred to also as optical axis orthogonal direction, shake correction direction and/or the like, and the XY plane may be referred to also as optical axis orthogonal plane, shake correction plane and/or the like.

In addition, in the following description, unless otherwise noted, the “radial direction” means the direction extending radially or centrifugally about the optical path or the optical axis, and the “circumferential direction” means the direction extending around the optical path or the optical axis. In addition, unless otherwise noted, the “outside” means the outside in the radial direction about the optical path or the optical axis, and the “inside” means the inside in the radial direction about the optical path or the optical axis.

In addition, in the following description, the four corners of the shape of camera module A in plan view (here, a square shape) may be identified by distinguishing them from each other. In this case, for convenience, the corner on the + side in the X direction and the + side in the Y direction is the first corner, the corner on the −side in the X direction and the + side in the Y direction is the second corner, the corner on the −side in the X direction and the −side in the Y direction is the third corner, and the corner on the + side in the X direction and the −side in the Y direction is the fourth corner.

As illustrated in FIG. 3, camera module A includes optical element driving apparatus 1 for achieving the AF function and OIS function, lens part 2 (an example of the optical element) composed of a cylindrical lens barrel housing a lens, and image-capturing part 5 for capturing the subject image formed by lens part 2.

The outside of optical element driving apparatus 1 is covered with cover 3. Cover 3 is a capped square cylinder member with a rectangular shape in plan view as viewed from the Z direction. Here, cover 3 has a square shape in plan view. Cover 3 includes substantially semicircular opening 301 in the top surface (the surface on the + side in the Z direction). Lens part 2 is exposed to the outside from opening 301 of cover 3. Cover 3 is fixed by bonding to base member 25 of OIS foundation part 20 of optical element driving apparatus 1, for example (see FIG. 4). Cover 3 is composed of a magnetic substance, and functions as a shield member that blocks the electromagnetic waves from the outside of optical element driving apparatus 1 and prevents magnetic interaction between the inside and the outside of optical element driving apparatus 1, for example.

Image-capturing part 5 is disposed on the image-capturing side (the − side in the Z direction) of optical element driving apparatus 1. Image-capturing part 5 includes image sensor substrate 501, and imaging element 502 and control part 503 mounted on image sensor substrate 501, for example. Imaging element 502 is composed of a CCD (charge-coupled device) image sensor, a CMOS (complementary metal oxide semiconductor) image sensor or the like, and captures the subject image formed by lens part 2, for example. Optical element driving apparatus 1 is mounted to image sensor substrate 501 and electrically connected to image sensor substrate 501.

Control part 503 is composed of a control IC (Integrated Circuit), and drives and controls optical element driving apparatus 1, for example. Control part 503 may be provided in image sensor substrate 501, or in a camera-equipped apparatus (here, smartphone M) in which camera module A is mounted.

Note that in a configuration adopted here, lens part 2 of OIS correction part 10 is movable in the optical axis direction and the direction orthogonal to the optical axis in optical element driving apparatus 1 with respect to image sensor substrate 501 with fixed position. However, for the purpose of focusing or shake correction, lens part 2 may be fixed (unmovable) and imaging element 502 may move (movable) in at least one of the optical axis direction and the optical axis orthogonal direction. In this case, imaging element 502 is an example of the optical element held by AF focusing part 11 or OIS correction part 10.

### Configuration of Optical Element Driving Apparatus 1

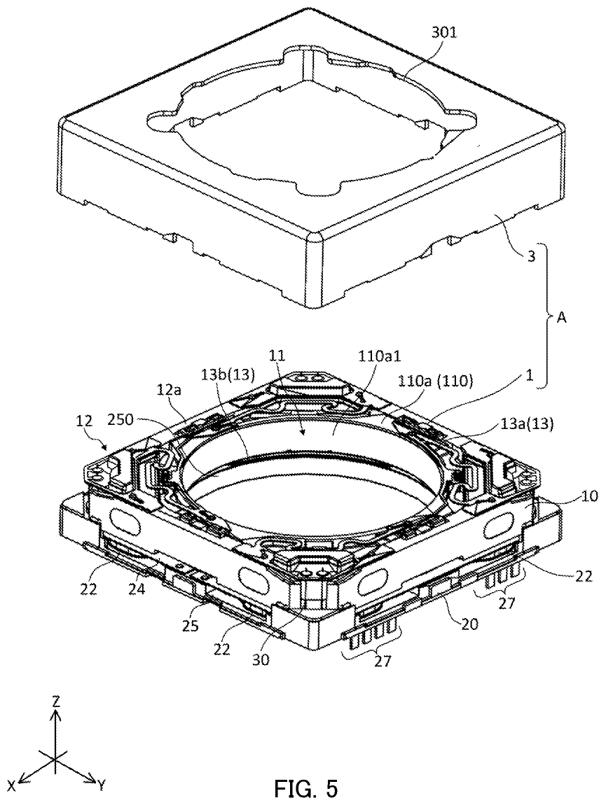

Next, a configuration of optical element driving apparatus 1 is described with reference to FIGS. 5 to 10. Note that in the description of the configuration of optical element driving apparatus 1, the + side in the Z direction is the “upper” side and the − side in the Z direction is the “lower” side for convenience.

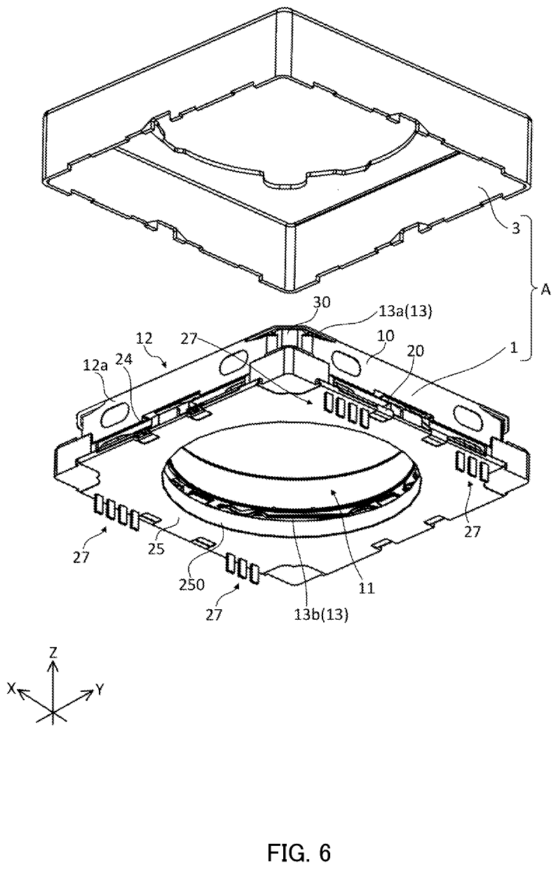

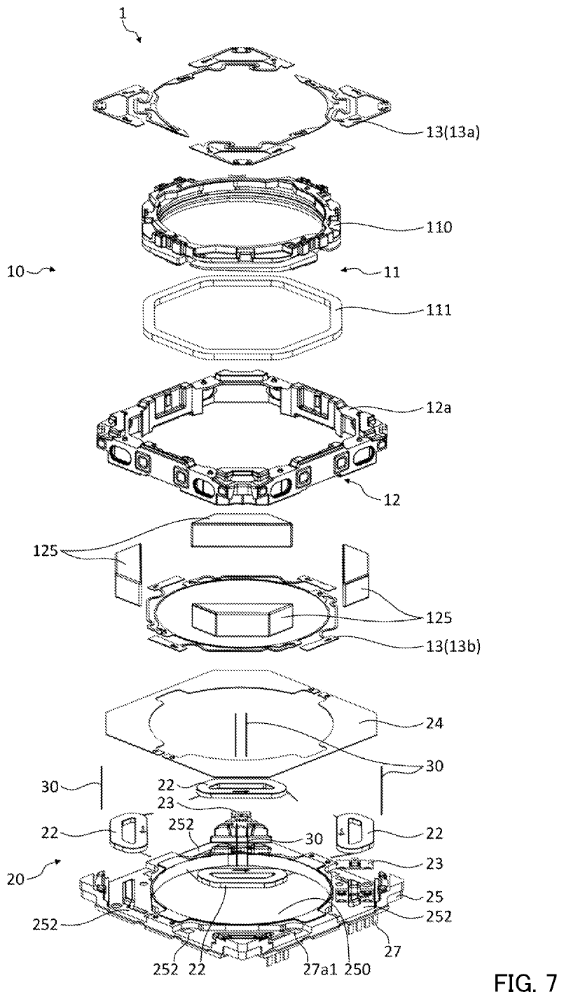

FIG. 5 is an exploded perspective view illustrating a state where cover 3 is detached from optical element driving apparatus 1 in camera module A as viewed from above. FIG. 6 is an exploded perspective view illustrating the state illustrated in FIG. 5 as viewed from below. FIG. 7 is an exploded perspective view illustrating an internal configuration of optical element driving apparatus 1 illustrated in FIG. 5 with cover 3 detached.

Optical element driving apparatus 1 includes OIS correction part 10, OIS foundation part 20, and suspension wire 30 serving as a wire member.

### OIS Correction Part 10

OIS correction part 10 is a part that includes an OIS magnet part making up an OIS voice coil motor as an example of the OIS driving part and sways in the optical axis orthogonal plane during shake correction. OIS foundation part 20 is a part including an OIS coil part. Specifically, a moving magnet system is employed for the OIS driving part of optical element driving apparatus 1. OIS correction part 10 is also “AF unit” including the AF driving part.

OIS correction part 10 is disposed above OIS foundation part 20 separately from OIS foundation part 20 on the + side in the Z direction (the light reception side in the optical axis direction or the upper side), and is coupled with OIS foundation part 20 by means of suspension wire 30.

OIS correction part 10 includes AF focusing part 11, AF holding part 12, and AF leaf spring supporting part 13 (upper leaf spring member 13a and lower leaf spring member 13b).

### AF Focusing Part 11

AF focusing part 11 is disposed separately from AF holding part 12 on the inside of AF holding part 12 in the radial direction, and is coupled with AF holding part 12 by means of upper leaf spring member 13a and lower leaf spring member 13b.

AF focusing part 11 is a part that includes a coil part making up an AF voice coil motor as an example of the AF driving part and moves in the Z direction (optical axis direction) with respect to AF holding part 12 at the time of focusing. AF holding part 12 is a part including a magnet part making up the AF voice coil motor. Specifically, a moving coil system is employed for the AF driving part of optical element driving apparatus 1.

AF focusing part 11 includes AF coil part 111 and lens holder 110 serving as a movable part.

Lens holder 110 can hold lens part 2 serving as an optical element. Lens holder 110 includes cylindrical lens holding part 110a. Lens part 2 is fixed by bonding to the inner peripheral surface of opening (lens housing opening) 110a1 of lens holding part 110a, for example. Note that the method of fixing lens part 2 to lens holder 110 is not limited to bonding, and other methods may be adopted.

Lens holder 110 is formed of a molding material composed of a PAR alloy (e.g., PAR/PC) obtained by mixing a plurality of resin materials including polyarylate (PAR) or PAR, for example. Since this increases the weld strength than known molding materials such as liquid crystal polymer (LCP: Liquid Crystal Polymer), the toughness and impact resistance can be ensured even when lens holder 110 is thinned. In this manner, the external size of optical element driving apparatus 1 can be reduced, and size reduction and weight reduction can be achieved.

Lens holder 110 includes an upper flange and a lower flange (not illustrated) radially outwardly protruding from the upper portion and lower portion of the outer peripheral surface of lens holding part 110a, and the region between the upper flange and lower flange in the outer peripheral surface is a continuous groove over the whole circumference. That is, lens holder 110 has a bobbin structure. AF coil part 111 is disposed in the groove of the outer peripheral surface of lens holder 110.

AF coil part 111 is a coil that is energized at the time of focusing. The both ends of AF coil part 111 are tied to a tying part (not illustrated) provided in lens holder 110.

### AF Holding Part 12

AF holding part 12 supports AF focusing part 11 in a movable manner in the optical axis direction by means of AF leaf spring supporting part 13. AF holding part 12 includes magnet part 125 and magnet holder 12a serving as a housing part.

Magnet holder 12a has a square quadrangular cylindrical shape in plan view in the Z direction. Magnet holder 12a surrounds the outer periphery of lens holder 110 and houses lens holder 110. Magnet holder 12a includes a magnet arrangement part for arranging magnet part 125 at portions corresponding to the four corners at the inner peripheral surface. The inner hollow part defined by magnet holder 12a and magnet part 125 mounted at magnet arrangement part makes up a lens holder housing opening for housing AF focusing part 11.

A grooves recessed radially inward is formed in a manner corresponding to each of the four corners at the outer peripheral surface of magnet holder 12a. Suspension wire 30 is disposed in each groove. A damper member (e.g., a silicone gel) may be disposed in this groove, and the operation of the OIS can be stabilized with the damper member by suppressing the generation of unnecessary resonance (high-order resonance mode).

In magnet holder 12a, lower leaf spring member 13b is fixed at the end surface on the − side in the Z direction (rear surface), and upper leaf spring member 13a is fixed at the surface on the + side in the Z direction (front surface).

Here, as with lens holder 110, magnet holder 12a is formed of a molding material composed of a PAR alloy (e.g., PAR/PC) obtained by mixing a plurality of resin materials including polyarylate (PAR) or PAR. This increases the weld strength, and thus the toughness and impact resistance can be ensured even when magnet holder 12a is thinned. In this manner, the external size of optical element driving apparatus 1 can be reduced, and size reduction and height reduction can be achieved.

Magnet part 125 includes four rectangular columnar permanent magnets (an example of the magnet). Magnet part 125 is fixed by bonding to the magnet arrangement part, for example. Here, magnet part 125 has a substantially isosceles trapezoidal shape in plan view.

In this manner, the space of each of the four corners (more specifically, the magnet arrangement part) of magnet holder 12a can be effectively used. Magnet part 125 is magnetized such that a magnetic field is formed in the radial direction across AF coil part 111 and in the optical axis direction across OIS coil part 22. Here, magnet part 125 is magnetized to N pole on the inner circumference side and to S pole on the outer circumference side.

The end surface (rear surface) of magnet part 125 on the −side in the Z direction protrudes to the − side in the Z direction than magnet holder 12a. Specifically, the height of OIS correction part 10 is defined by magnet part 125. In this manner, the height of OIS correction part 10 can be suppressed as much as possible in accordance with the size of magnet part 125 for ensuring the magnetic force, and height reduction of optical element driving apparatus 1 can be achieved.

The AF voice coil motor (AF driving part) is configured with magnet part 125 and AF coil part 111 described above. In addition, magnet part 125 is used for both the AF magnet part and OIS magnet part.

### AF Leaf Spring Supporting Part 13

AF leaf spring supporting part 13 elastically supports AF focusing part 11 with respect to AF holding part 12. AF leaf spring supporting part 13 includes upper leaf spring member 13a and lower leaf spring member 13b. Here, the leaf spring making up upper leaf spring member 13a and lower leaf spring member 13b is composed of beryllium copper, nickel copper, or stainless-steel, for example.

Upper leaf spring member 13a is mounted in magnet holder 12a so as to support lens holder 110 from the upward opening side of lens holder 110. Upper leaf spring member 13a is fixed outside to the surface of magnet holder 12a on the + side in the Z direction (front surface), and fixed inside to the surface of lens holder 110 on the + side in the Z direction (front surface). In upper leaf spring member 13a, the arm shape extending in the middle portion between the outside and inside is elastically deformable, which allows the inner portion of upper leaf spring member 13a to be relatively displaced in the Z direction with respect to the outer portion of upper leaf spring member 13a.

Upper leaf spring member 13a is divided into a power feeding path portion connected to suspension wire 30 and used as a power feeding path to the AF control part (not illustrated), and a signal path portion connected to suspension wire 30 and used as a signal path for transmitting a control signal to the AF control part (not illustrated). Upper leaf spring member 13a making up the power feeding path portion is connected to AF coil part 111 by soldering at the tying part provided in magnet holder 12a.

Lower leaf spring member 13b is fixed outside to the surface (rear surface) of magnet holder 12a on the − side in the Z direction, and fixed inside to the surface (rear surface) of lens holder 110 on the − side in the Z direction. In lower leaf spring member 13b, the arm shape extending in the middle portion between the outside and inside is elastically deformable, which allows the inner portion of lower leaf spring member 13b to be relatively displaced in the Z direction with respect to the outer portion of lower leaf spring member 13b.

### OIS Foundation Part 20

OIS foundation part 20 supports in a swayable manner OIS correction part 10 in the optical axis orthogonal direction by means of suspension wire 30. OIS foundation part 20 includes OIS coil part 22, magnetic sensor part 23, protection member 24, base member 25 serving as a fixing part and wiring member 27.

### OIS Coil Part 22

OIS foundation part 20 includes OIS coil part 22 at the position of each of the four corners facing magnet part 125 in the Z direction (optical axis direction). OIS coil part 22 is a coil that is energized at the time of shake correction. Four OIS coil parts 22 corresponding to magnet parts 125 are provided. Here, four coil parts 22 are air-core coils.

The sizes and arrangements of OIS coil part 22 and magnet part 125 are set such that the magnetic field radiated from the bottom surface of magnet part 125 passes in the Z direction across the long side of each OIS coil part 22. The combination of magnet part 125 and OIS coil part 22 makes up the OIS voice coil motor (OIS driving part).

The end portion of the lead provided at both ends of each OIS coil part 22 is connected by soldering to coil terminal element 27a1 (an example of the coil terminal) of wiring member 27 provided at base member 25. Specifically, each OIS coil part 22 is directly connected to coil terminal element 27a1 without interposing a substrate therebetween. Base member 25 is provided with coil recess (an example of the second recess) 252 for disposing each OIS coil part 22, and each OIS coil part 22 is disposed in each of coil recesses 252 of the four corners. The arrangement of each OIS coil part 22 to base member 25 and the like are elaborated later.

### Magnetic Sensor Part 23

OIS foundation part 20 includes magnetic sensor part 23 in the hollow part at the center of the corresponding OIS coil part 22 at the first corner and the fourth corner of the four corners. Magnetic sensor part 23 detects the position of OIS correction part 10 in the optical axis orthogonal plane specified by detecting the magnetic field formed by magnet part 125 with a Hall element. This determination is based on the relative position of magnet part 125 and the Hall element in the optical axis orthogonal plane. Magnetic sensor part 23 includes a Hall element chip assembly. The Hall element chip assembly includes a Hall element (an example of the magnetic sensor), and a magnetic sensor substrate where a chip of the Hall element is mounted. The magnetic sensor substrate is a printed board (PWB: Printed Wiring Board), for example.

The Hall element is provided at the center portion of the main surface of the magnetic sensor substrate, and a substrate side terminal part is provided in a region around it. The substrate side terminal part is connected by soldering to a substrate terminal element (an example of the substrate terminal) of wiring member 27 provided in base member 25. Specifically, each Hall element is connected to the substrate terminal element with the magnetic sensor substrate therebetween. Base member 25 is provided with a substrate recess (an example of the first recess) for disposing each Hall element chip assembly. Each Hall element chip assembly is disposed in the substrate recess at each of the four corners.

### Base Member 25

Base member 25 is a member with a square shape in plan view including center opening 250 through which the optical path or the optical axis passes. Base member 25 supports lens holder 110 and magnet holder 12a from their lower opening sides. Base member 25 is composed of non-conductive materials such as synthetic resins, e.g., liquid crystal polymer (LCP: Liquid Crystal Polymer). Wiring member 27 is insert-molded to base member 25.

Wiring member 27 is a metal plate-shaped member insert-molded to base member 25. Wiring member 27 is composed of conductive materials such as beryllium copper, nickel copper and stainless-steel, for example.

Wiring member 27 includes a coil terminal member, a substrate terminal member, and a wire terminal member.

The coil terminal member includes coil terminal element 27a1 and a coil terminal connecting part. Coil terminal element 27a1 is exposed to the upper side at the bottom portion of coil recess 252 provided in base member 25. Coil terminal element 27a1 is directly connected by soldering to the lead of OIS coil part 22 disposed in coil recess 252. The coil terminal connecting part protrudes from the outer edge of base member 25, and can be connected to external image sensor substrate 501. In the coil terminal member, the portions other than the portion exposed or protruded from base member 25 are embedded inside base member 25.

The substrate terminal member includes a substrate terminal element and a substrate terminal connecting part. The substrate terminal element is exposed to the upper side at the bottom portion of the substrate recess provided in base member 25. The substrate terminal element is directly connected by soldering to the substrate side terminal part of the Hall element chip assembly of magnetic sensor part 23 disposed in the substrate recess. The substrate terminal connecting part protrudes from the outer edge of base member 25, and can be connected to external image sensor substrate 501. Substrate terminal member, the portions other than the portion exposed or protruded from base member 25 are embedded inside base member 25.

The wire terminal member includes a wire terminal element and a wire terminal connecting part. The wire terminal element is disposed so as to be exposed upward and downward at the four corners of base member 25, and directly connected by soldering to the lower end of suspension wire 30 inserted through an insertion hole formed therein. The wire terminal connecting part protrudes from the outer edge of base member 25, and can be connected to external image sensor substrate 501. In the wire terminal member, the portions other than the portion exposed or protruded from base member 25 are embedded inside base member 25.

### Protection Member 24

Protection member 24 is provided to cover the region surrounding center opening 250 at base member 25. Protection member 24 is a thin plate member or film member composed of a non-conductive material such as a resin material. To completely cover the arrangement region of OIS coil part 22, protection member 24 is interposed between OIS coil part 22 and magnet part 125 in the Z direction. In this manner, the collision between OIS coil part 22 and magnet part 125 due to an external impact can be prevented. In addition, the occurrence of short circuit due to the contact of lower leaf spring member 13b made of metal with OIS coil part 22 made of metal can be prevented.

### Suspension Wire 30

Suspension wire 30 is a rod-shaped elastic member extending along the Z direction. A group of two suspension wires 30 is disposed in a manner corresponding to each of the four corners of magnet holder 12a. Note that a group of three suspension wires 30 may be disposed in a manner corresponding to each of the four corners of magnet holder 12a. In each suspension wire 30, one end (lower end) is fixed to OIS foundation part 20, and the other end (upper end) is fixed to OIS correction part 10 (more specifically, upper leaf: spring member 13a). OIS correction part 10 is supported in a swayable manner in the optical axis orthogonal plane by means of suspension wire 30.

Suspension wire 30 is extended between base member 25 and upper leaf spring member 13a so as to support magnet holder 12a. The group of suspension wires 30 disposed at each of the four corners of magnet holder 12a is connected to the same upper leaf spring member 13a. The group of suspension wires 30 disposed at each of the four corners of magnet holder 12a is disposed side by side with the same distance from the optical axis of lens part 2.

Here, a pair of suspension wires 30 is disposed in a manner corresponding to each of the four corners. With such an arrangement, OIS correction part 10 with the same weight can be supported even when the spring constant per wire is reduced (in other words, even when the flexibility is increased) in comparison with the case where one suspension wire 30 is disposed at each of the four corners. In this manner, both the stable support performance and the sway performance in shake correction can be achieved. In addition, since the stress is less concentrated at individual suspension wire 30, the durability can be improved.

Suspension wires 30 disposed in a manner corresponding to each of the four corners are all or selectively used as the power feeding path to AF coil part 111. Note that the number of suspension wires 30 is not limited to eight, and may be greater than eight as long as the performance of swayable supporting OIS correction part 10 can be maintained.

### Details of Configuration of Upper Leaf Spring Member 13a

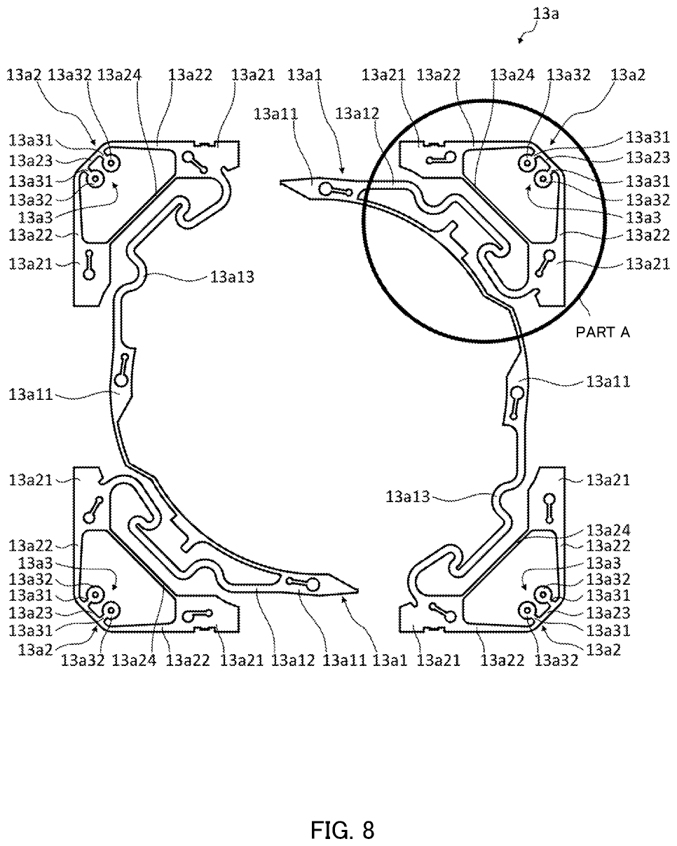

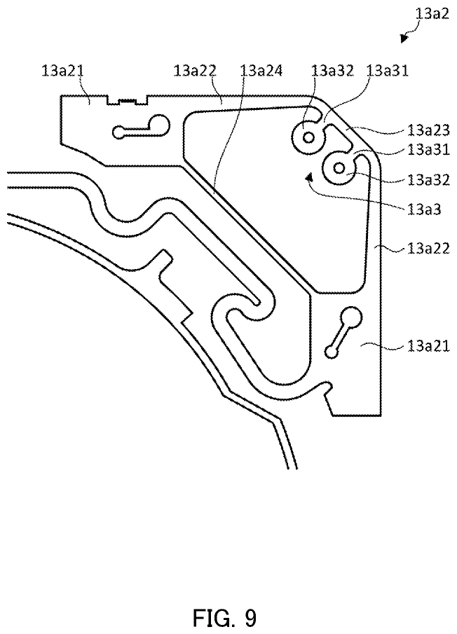

FIG. 8 is a plan view illustrating upper leaf spring member 13a as viewed from above. FIG. 9 is an enlarged plan view illustrating a part A of upper leaf spring member 13a in FIG. 8 in an enlarged manner.

Upper leaf spring member 13a includes lens holder side connecting part 13a1 serving as a movable part side connecting part, magnet holder side connecting part 13a2 serving as a housing part side connecting part, and suspension wire side connecting part 13a3 serving as a wire member side connecting part. Upper leaf spring member 13a is mainly separated into two pieces. A half piece of upper leaf spring member 13a separated into two pieces is composed of one lens holder side connecting part 13a1, two magnet holder side connecting parts 13a2, and two suspension wire side connecting parts 13a3.

Lens holder side connecting part 13a1 is connected to lens holder 110 at two first connecting parts 13a11. First arm part 13a12 on one side and second arm part 13a13 on the other side extend along the curve of lens holder 110 from first connecting part 13a11 of lens holder side connecting part 13a1.

Magnet holder side connecting part 13a2 is connected to magnet holder 12a on the + side in the Z direction of the groove where suspension wire 30 is disposed. Four magnet holder side connecting parts 13a2 are formed around the four corners of magnet holder 12a over the adjacent two sides of magnet holder 12a. Magnet holder side connecting part 13a2 includes two second connecting parts 13a21, two extension parts 13a22, coupling part 13a23, and reinforcement part 13a24. Each second connecting part 13a21 is connected to magnet holder 12a at an upper portion of the side close to the four corners of magnet holder 12a. Two extension parts 13a22 extend from second connecting part 13a21 toward each of the four corners of magnet holder 12a at adjacent two sides of magnet holder 12a. Coupling part 13a23 couples adjacent two extension parts 13a22 at each of the four corners of magnet holder 12a. Reinforcement part 13a24 reinforces two second connecting parts of one magnet holder side connecting part 13a2 while ensuring conductivity by connecting them with a linear shape with the shortest distance between the two second connecting parts 13a21.

Suspension wire side connecting part 13a3 is connected by soldering to the upper end of suspension wire 30. Suspension wire side connecting part 13a3 formed at each of the four corners of magnet holder 12a is connected to the same magnet holder side connecting part 13a2 so as to set the group of suspension wires 30 at the four corners as a single electrical path.

Suspension wire side connecting part 13a3 includes two bridge parts 13a31 and a pair of third connecting parts 13a32. Two bridge parts 13a31 bridge from coupling part 13a23 to each suspension wire 30 of the group of suspension wires 30 disposed at each of the four corners of magnet holder 12a. The width of bridge part 13a31 in the direction intersecting the direction of connecting coupling part 13a23 and suspension wire 30 is constant and smaller than the width of the portion surrounding the periphery of third connecting part 13a32. The pair of third connecting parts 13a32 is connected to each suspension wire 30 of the group of suspension wires 30 at the end portions of two bridge parts 13a31. Note that the number of bridge parts 13a31 and third connecting parts 13a32 needs only to be the same as the number of suspension wires 30 of the group of suspension wires 30.

In the case where the pair of third connecting parts 13a32 is integrated with one another, if one third connecting part 13a32 and one suspension wire 30 are joined by soldering and thereafter the other third connecting part 13a32 and the other suspension wire 30 are joined by soldering, the heat is transmitted to the previously joined solder through the connection of the pair of third connecting parts 13a32, thus causing re-melting, which leads to the necessity of adjustment of the connection means. In view of this, the pair of third connecting parts 13a32 separated and isolated by means of two separated, slit-shaped bridge parts 13a31 can achieve simple connection.

### Modification 1

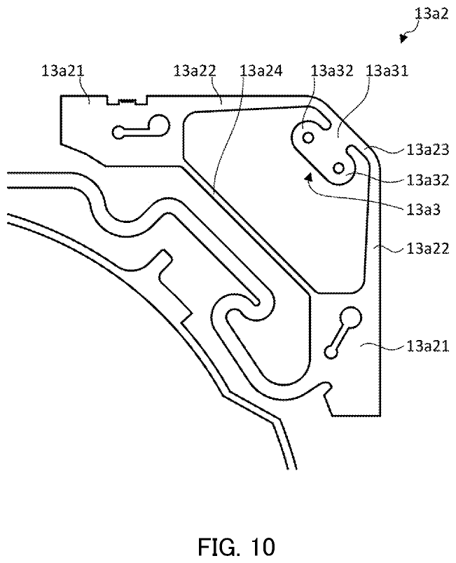

FIG. 10 is an enlarged plan view illustrating part A in FIG. 8 of upper leaf spring member 13a according to modification 1 in an enlarged manner. In modification 1, the same configurations as those of the above-mentioned embodiments of the present invention are denoted with the same reference numerals and the description thereof is omitted. Their features are described below.

Suspension wire side connecting part 13a3 includes one bridge part 13a31 and the pair of third connecting parts 13a32. One bridge part 13a31 singly bridges from coupling part 13a23 to the group of suspension wires 30 disposed at each of the four corners of magnet holder 12a. Bridge part 13a31 is formed such that the width intersecting the connecting direction of coupling part 13a23 and the group of suspension wires 30 is a constant width smaller than the width of the portion surrounding the periphery of the plurality of connecting parts. The pair of third connecting parts 13a32 is connected to each suspension wire 30 of the group of suspension wires 30 at the end portion of bridge part 13a31. The pair of third connecting parts 13a32 is integrated with each other. With the single bridge part 13a31 and the pair of third connecting parts 13a32 integrated with each other, the displacement of suspension wire 30 is further reduced. Note that the number of third connecting parts 13a32 needs only to be equal to the number of suspension wires 30 in the group of suspension wires 30.

### Modification 2

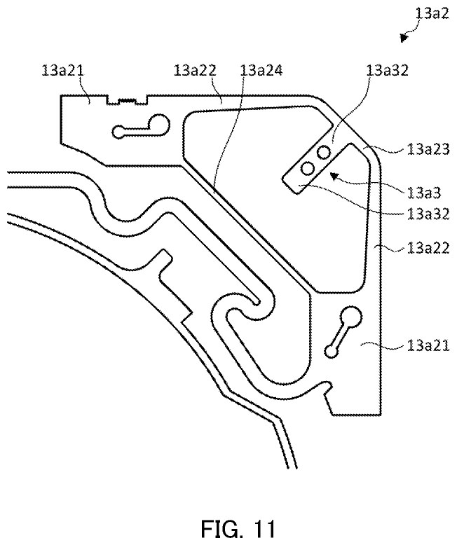

FIG. 11 is an enlarged plan view illustrating in an enlarged manner the part A in FIG. 8 of upper leaf spring member 13a according to modification 2. In modification 2, the same configurations as those of the above-mentioned embodiments of the present invention are denoted with the e same reference numerals and the description thereof is omitted. Their features are described below.

The group of suspension wires 30 disposed at each of the four corners of magnet holder 12a is disposed side by side in the radial direction. Suspension wire 30 remote from the optical axis of lens part 2 is set to have a greater wire diameter than suspension wire 30 close to the optical axis of lens part 2, or is composed of a batch of wire members or a twisted wire member. This configuration can improve the strength of suspension wire 30 remote from the optical axis of lens part 2, to which stress is more likely to be applied than suspension wire 30 close to the optical axis of lens part 2. Here, the arrangement of the group of suspension wires 30 is represented by the arrangement of the two third connecting parts 13a32 of suspension wire side connecting part 13a3 of upper leaf spring member 13a. Note that here, suspension wire side connecting part 13a3 is not provided with bridge part 13a31, and two third connecting parts 13a32 are disposed side by side in the radial direction of lens part 2.

### Supplementary Notes

The above-described embodiments and modifications are summarized as follows.

Optical element driving apparatus 1 includes lens holder 110 that can hold lens part 2. Optical element driving apparatus 1 includes cylindrical magnet holder 12a with a rectangular shape in plan view that surrounds the outer periphery of lens holder 110 and houses lens holder 110. Optical element driving apparatus 1 includes base member 25 disposed on one side with respect to lens holder 110 and magnet holder 12a in the optical axis direction. Optical element driving apparatus 1 includes upper leaf spring member 13a that supports lens holder 110 such that lens holder 110 is movable with respect to magnet holder 12a in the optical axis direction. Optical element driving apparatus 1 includes support suspension wire 30 that supports magnet holder 12a such that magnet holder 12a is movable with respect to base member 25 in the optical axis orthogonal direction. Suspension wire 30 is configured such that a wire group composed of two or more wire members is disposed at each of the four corners of magnet holder 12a and connected to common leaf spring member 13a.

With this configuration, since the group of two or more suspension wires 30 is disposed at each of the four corners of magnet holder 12a, the spring constant per suspension wire 30 can be reduced, and the stress applied to one suspension wire 30 can be reduced. In this manner, the damage to suspension wire 30 can be suppressed. In addition, since the group two suspension wires 30 is connected to the same upper leaf spring member 13a at each of the four corners of magnet holder 12a, the group of suspension wires 30 forms a single electrical path, and thus the stability of the electric connection can be improved

Upper leaf spring member 13a includes magnet holder side connecting part 13a2 connected to magnet holder 12a at each of the four corners of magnet holder 12a. Magnet holder side connecting part 13a2 includes two extension parts 13a22 extending along adjacent two sides of magnet holder 12a. Magnet holder side connecting part 13a2 includes coupling part 13a23 that couples two extension parts 13a22 together at the corresponding corner.

With this configuration, since coupling part 13a23 couples two extension parts 13a22 together, unnecessary behavior in the region around magnet holder side connecting part 13a2 of upper leaf spring member 13a can be suppressed. In addition, since the group of suspension wires 30 is connected on coupling part 13a23 side and the strength around the group of suspension wires 30 is increased with two extension parts 13a22 and coupling part 13a23 coupling between extension parts 13a22, excessive deviation of the group of suspension wires 30 can be prevented.

Upper leaf spring member 13a includes suspension wire side connecting part 13a3 connected to suspension wire 30 at each of the four corners of magnet holder 12a. Suspension wire side connecting part 13a3 includes one bridge part 13a31 that collectively bridges from coupling part 13a23 to all suspension wires 30 included in the corresponding wire group. Suspension wire side connecting part 13a3 includes a plurality of third connecting parts 13a32 connected to each suspension wire 30 of the corresponding wire group at the end portion of the single bridge part 13a31.

With this configuration, since the group of suspension wires 30 is connected to the plurality of third connecting parts 13a32 with the single bridge part 13a31, the displacement of suspension wire 30 can be suppressed.

Upper leaf spring member 13a includes suspension wire side connecting part 13a3 connected to suspension wire 30 at each of the four corners of magnet holder 12a. Suspension wire side connecting part 13a3 includes a plurality of bridge parts 13a31 that individually bridges from coupling part 13a23 to all suspension wires 30 included in the corresponding wire group. Suspension wire side connecting part 13a3 includes a plurality of third connecting parts 13a32 respectively connected to all suspension wires 30 included in the corresponding wire group at the end portions of the plurality of bridge parts 13a31.

With this configuration, with the plurality of bridge parts 13a31 bridging from coupling part 13a23 to each suspension wire 30 of the group of suspension wires 30 disposed at each of the four corners of magnet holder 12a, upper leaf spring member 13a can easily deform to follow the state of each suspension wire 30, and the stress applied to each suspension wire 30 can be reduced.

All suspension wires 30 included in the wire group is disposed side by side in the radial direction at each of the four corners of magnet holder 12a.

With this configuration, since the group of suspension wires 30 is disposed along the movement direction, it is not necessary to provide components for preventing the contact between suspension wires 30.

Camera module A includes optical element driving apparatus 1. Camera module A includes lens part 2. Camera module A includes an image-capturing part for capturing the subject image formed by lens part 2.

With this configuration, blurring of lens part 2 can be suppressed, and the image-capturing part can capture clean subject images.

The camera-equipped d apparatus is an information apparatus or a transport apparatus. The camera-equipped apparatus includes camera module A. The camera-equipped apparatus includes an image processing part for processing image information obtained by camera module A.

With this configuration, blurring of lens part 2 can be suppressed, and the image processing part can process the image information of clean subject images.

### Other Notes

The above embodiments are merely examples of embodiments for implementing the invention, and the technical scope of the invention should not be interpreted as limited by them. In other words, the invention can be implemented in various forms without deviating from the main features. For example, upper leaf spring member 13a is divided into two half pieces above, but it may be further divided into further pieces.

### REFERENCE SIGNS LIST

1 Optical element driving apparatus
2 Lens part (Optical element)
3 Cover
5 Image-capturing part
10 OIS correction part
11 AF focusing part
12 AF holding part
12a Magnet holder (Housing part)
13 AF leaf spring supporting part
13a Upper leaf spring member (Leaf spring member)
13a1 Lens holder side connecting part
13a11 First connecting part
13a12 First arm part
13a13 Second arm part
13a2 Magnet holder side connecting part (Housing part side connecting part)
13a21 Second connecting part
13a22 Extension part
13a23 Coupling part
13a24 Reinforcement part
13a3 Suspension wire side connecting part (Wire member side connecting part)
13a31 Bridge part
13a32 Third connecting part
13b Lower leaf spring member
20 OIS foundation part
22 OIS coil part
23 Magnetic sensor part
24 Protection member
25 Base member (Fixing part)
27 Wiring member
27a1 Coil terminal element
30 Suspension wire (Wire member)
110 Lens holder (Movable part)
110a Lens holding part
110a1 Lens housing opening
111 AF coil part
125 Magnet part
250 Center opening
252 Coil recess
301 Opening
501 Image sensor substrate
502 Imaging element
503 Control part

1. An optical element driving apparatus, comprising:
a movable part configured to hold an optical element;
a housing part with a cylindrical shape configured to surround an outer periphery of the movable part and house the movable part, the housing part having a rectangular shape in plan view;
a fixing part disposed on one side in an optical axis direction with respect to the movable part and the housing part;
a leaf spring member configured to support the movable part such that the movable part is movable in the optical axis direction with respect to the housing part; and
a wire member configured to support the housing part such that the housing part is movable in an optical axis orthogonal direction with respect to the fixing part, wherein
the wire member is configured such that a wire group including two or more wire members is disposed at each of four corners of the housing part and connected to a common leaf spring member.

2. The optical element driving apparatus according to claim 1, wherein:
the leaf spring member includes a housing part side connecting part connected to the housing part at each of the four corners of the housing part, and
the housing part side connecting part includes:
two extension parts extending along two sides adjacent to each other of the housing part, and
a coupling part configured to couple the two extension parts at a corresponding corner.

3. The optical element driving apparatus according to claim 2, wherein:
the leaf spring member includes a wire member side connecting part connected to the wire member at each of the four corners of the housing part,
the wire member side connecting part includes:
one bridge part configured to collectively bridge from the coupling part to all wire members included in a corresponding wire group, and
a plurality of connecting parts connected at an end portion of the one bridge part to each of all wire members included in the corresponding wire group.

4. The optical element driving apparatus according to claim 2, wherein:
the leaf spring member includes a wire member side connecting part connected to the wire member at each of the four corners of the housing part, and
the wire member side connecting part includes:
a plurality of bridge parts configured to individually bridge from the coupling part to all wire members included in a corresponding wire group, and
a plurality of connecting parts connected at end portions of the plurality of bridge parts to each of all wire members included in the corresponding wire group.

5. The optical element driving apparatus according to claim 1, wherein all wire members included in the wire group are disposed side by side in a radial direction at each of the four corners of the housing part.

6. A camera module, comprising:
the optical element driving apparatus according to claim 1;
the optical element; and
an image-capturing part configured to capture a subject image formed by the optical element.

7. A camera-equipped apparatus that is an information apparatus or a transport apparatus, the camera-equipped apparatus comprising:
the camera module according to claim 6; and
an image processing part configured to process image information obtained by the camera module.
